(19) United States
(12) Patent Application Publication
(10) Pub. No.: US 2008/0007517 A9
(43) Pub. Date: Jan. 10, 2008

(54) Electrical damping system

(75) Inventors: Michael A. Peshkin, Evanston, IL (US); J. Edward Colgate, Evanston, IL (US); Joshua Mehling, League City, TX (US); David W. Weir, Evanston, IL (US)

Correspondence Address: MCANDREWS HELD & MALLOY, LTD, 500 WEST MADISON STREET, SUITE 3400, CHICAGO, IL, 60661, US

(73) Assignee: Northwestern University

(21) Appl. No.: 11/359,105

(22) Filed: Feb. 22, 2006

Related U.S. Application Data
(60) Provisional application No. 60/655,963, filed on Feb. 23, 2005.

(51) Int. Cl. G09G 5/00

(52) U.S. Cl. 345/156

(57) ABSTRACT

An electrical damping system provides damping over a wide range of frequencies including high frequencies. The system includes a resistance in parallel with an electric motor or series connected resistance and capacitance in parallel with the electric motor. In another embodiment, an electrical damping system is provided for a motor having a delta or wye motor winding configuration.

### CROSS-REFERENCE TO RELATED APPLICATIONS

This application claims the priority of provisional application Ser. No. 60/655,963, filed Feb. 23, 2005. That application is hereby incorporated by reference.

### STATEMENT REGARDING FEDERALLY SPONSORED RESEARCH OR DEVELOPMENT

This work was supported by the National Science Foundation (NSF) award: #IIS-0117489.

### BACKGROUND OF THE INVENTION

A great challenge in the field of robotics, and human-robot interaction specifically, has been to develop methods of relaying tactile, or haptic, information to people. This is accomplished through the use of haptic displays. Haptic display devices, however, have a limited range of virtual environments, objects, and surfaces that they are capable of simulating effectively. For common impedance causality haptic displays, which output a force in response to a user's motion, i.e. position, velocity, acceleration, etc., these device limitations can be described in terms of an impedance range. Impedances, or dynamic relationships between velocities and forces, are quite varied in the real or physical world but only a limited range of impedances can be exhibited with a given haptic display. For example, in the physical world, devices are limited in the low impedance range by their inherent friction, mass, and other physical characteristics. This means that a user's motion while interacting with a device will never feel completely unhindered because some minimum mass, minimum damping, or other small resistive force will always be felt. On the other hand, haptic displays can be limited in the high impedance range by sampled data effects, time delay, sensor quantization, or noise. See, for instance, J. E. Colgate and G. Schenkel, “Passivity of a Class of Sampled-Data Systems: Application to Haptic Interfaces,” Proceedings of the IEEE American Control Conference, Baltimore, Md., 1994. This means that a user's motion while interacting with a haptic device will never feel as completely constrained as it will while interacting with a stiff surface. It is well known that haptic devices often lose stability and begin to oscillate when attempting to represent high impedances.

An obvious goal in haptic display design is to maximize impedance range so that a wider range of virtual environments can be modeled stably and effectively for the user. Aside from force feedback and careful mechanical design, little can be done to improve the performance of a device in its low impedance range but there is great interest in the potential for expanding the high impedance range of haptic displays. Past work towards this goal can, for the most part, be classified under one of two headings. The first of these is the use of psychophysical means to understand how people interpret the feel of surfaces and impacts. Novel modeling techniques can then be used, with these results in mind, to make a user think that a virtual surface has a higher impedance than the device is otherwise capable of rendering. In fact, it has been shown that perceived stiffness or virtual wall hardness can be affected by means other than strictly increasing the stiffness and damping of the virtual surface model. See for example, S. E. Salcudean and T. D. Vlaar, “On the Emulation of Stiff Walls and Static Friction with a Magnetically Levitated Input/Output Device,” ASME Journal of Dynamics, Measurement, and Control, Vol. 119, pp. 127-132, March 1997 and D. A. Lawrence, A. M. Dougherty, L. Y. Pao, Y. P. Yiannis, and M. A. Salada, “Rate-Hardness: A New Performance Metric For Haptic Interfaces,” IEEE Transactions on Robotics and Automation, Vol. 16, No. 4, pp. 357-371, August 2000. In contrast to developing novel techniques to work within a given device's limits, another method for improving the haptic display of virtual environments is to physically expand the range of impedances that a device is capable of displaying without exhibiting unstable limit cycle behavior. This is especially interesting because improvements made to a device itself will increase the effectiveness of both traditional virtual environment models and the more complex models that employ perceptual techniques.

To improve upon the limiting characteristics of the zero-order hold better methods for approximating the behavior of continuous systems have been developed as described in R. E. Ellis, M. A. Jenkins and N. Sarkar, “Numerical Methods for the Force Reflection Contact,” ASME Transactions of Dynamic Systems, Modeling, and Control, Vol. 119, No. 4, pp. 768-774, 1997 and R. B. Gillespie and M. R. Cutkosky, “Stable User-Specific Haptic Rendering of the Virtual Wall,” Proceedings of the ASME International Mechanical Engineering Congress and Exposition, DSC 58, Atlanta, pp. 397-406, November 1996. Another approach to increasing impedance range involved a method for both measuring and dissipating excess energy that could cause instabilities as described in B. Hannaford and J. Ryu, “Time Domain Passivity Control of Haptic Interfaces,” IEEE Conference on Robotics and Automation, Seoul, Korea, pp. 1863-1869, 2001. The limit cycle behavior of a haptic knob and its relation to the sample time and position quantization of the display device has also been discussed in C. Hasser, The Effects Of Displacement Quantization and Zero-Order Hold On The Limit Cycle Behavior Of Haptic Knobs, Ph.D. Dissertation, Stanford University, December 2001. Further, in J. E. Colgate and J. M. Brown, “Factors Affecting the Z-Width of a Haptic Display,” Proceedings of the IEEE International Conference on Robotics and Automation, San Diego, Calif., Vol. 4, pp. 3205-10, 1994, the authors investigated how the discrete characteristics of a system such as encoder resolution and sample time can affect the ability of a haptic display to render stable virtual walls. They found that, far beyond any other changes that were made to their system, the addition of physical mechanical damping to the haptic display provided the greatest increase in device impedance range. Introducing physical mechanical damping as a means to improve performance shows great promise experimentally and it is relatively easy to implement. Also, it is a physical characteristic rather than a discrete representation, thus, it is guaranteed to dissipate energy rather than contribute to the instabilities itself. This is, of course, a greater guarantee than discrete time based improvements can provide. Adding physical mechanical damping is not without problems, however. Using a viscous mechanical damper connected to the output shaft of a direct drive haptic display improves performance at a virtual wall boundary, but at the cost of performance outside the virtual wall. Away from the wall, the user still feels the physical damping as he tries to move about freely. This adversely impacts the range of low impedances that the device is capable of displaying. To get around this problem, negative virtual damping can be used so that the device assists the user's motion outside the wall, canceling out any effects of the mechanical damper. See for example, J. M. Brown, A Theoretical and Experimental Investigation Into The Factors Affecting The Z-Width of a Haptic Display, M.S. Thesis, Northwestern University, March 1995 and B. Chang, On Damped Manipulator with Damping Compensation for the Haptic Interface in a Virtual Environment, M.S. Thesis, Northwestern University, June 1994. This technique, in theory, makes the device more transparent while still preserving the damping at the virtual wall boundary. In practice, however, viscous mechanical dampers can be highly nonlinear, temperature dependent, and unpredictable. Thus, negative virtual damping cannot be added based only on a simple model of the damper. Forces must be measured in real-time and compensated for accordingly. This necessitates a more complex device design that might not be desired. Even with the incorporation of force sensing, this method cannot get around a more fundamental problem with mechanical dampers, however. Viscous mechanical dampers are usually big and bulky, messy, hard to implement into designs, and the viscous fluids that they rely on are hard to work with and can often cause damage to other components in the device. Thus, in many practical applications, the improvements associated with additional mechanical damping are difficult to achieve in reality. Therefore, it is desirable to look for an alternative means of increasing the physical damping of a haptic display.

### BRIEF SUMMARY OF THE INVENTION

In accordance with the present invention, the disadvantages of prior damping systems have been overcome. The damping system of the present invention is an electrical damping system that is not tuned but that provides broadband dampening over a wide range of frequencies including high frequencies.

In accordance with one embodiment of the present invention, the system includes an electric motor and the electrical damping system includes a resistive circuit connected in parallel with the motor. In a preferred embodiment, the electrical damping system also includes a capacitive circuit connected in series with the resistive circuit and in parallel with the motor.

In accordance with another feature of the present invention, the system provides damping for frequencies in the range of 10 Hz-1000 Hz.

In accordance with a further feature of the present invention, the damping system is used in a feedback control system to damp high feedback gain that could otherwise make the system unstable.

In accordance with another feature of the present invention, the damping system is used in applications in which at least a portion of the energy to be damped is internal to the system such as where the energy arises from the control of a device, e.g. the motor, itself. One such application is in a haptic display.

In accordance with another embodiment of the present invention, the electrical damping system may be coupled across one or more windings of a motor. In this embodiment, the damping system may include a resistance, a short, or a circuit having a current voltage characteristic with a negative slope, etc.

In accordance with a further embodiment of the invention, one winding or a linear combination of windings is used for voltage sensing and another winding or a linear combination of other windings is used for actuation, i.e. to create a torque that opposes the velocity of the motor's rotor.

These and other advantages and novel features of the present invention, as well as details of an illustrated embodiment thereof, will be more fully understood from the following description and drawings.

### BRIEF DESCRIPTION OF THE SEVERAL VIEWS OF THE DRAWING

FIG. 1 is an illustration of an electrically damped system without frequency dependency;

FIG. 2 is an illustration of an electrically damped system with frequency dependence;

FIG. 3 is an illustration of a model of a one degree-of-freedom haptic display with electrical damping;

FIG. 4 is a graph illustrating the magnitude portion of the Bode plot for the torque/current transfer function A(s) for electrical damping of 0.00755 Nms/rad;

FIG. 5 is a graph illustrating the magnitude of the Bode plot for the torque/velocity function Z(s) for electrical damping of 0.00755 Nms/rad;

FIG. 6 is a graph illustrating the theoretical effective damping for a system with electrical damping of 0.00755 Nms/rad;

FIG. 7 is a graph illustrating the apparent inertia for a system with electrical damping of 0.00755 Nms/rad;

FIG. 8 is a Z-width plot of the average stability boundary for various levels of electrical damping;

FIG. 9 is a circuit diagram of a delta winding configuration for a motor;

FIG. 10 is a circuit diagram of a wye motor winding configuration;

FIG. 11 is a circuit diagram illustrating another embodiment of the damping circuit of the present invention for a delta configuration of motor windings;

FIG. 12 is another embodiment of the damping circuit of the present invention for a motor with a delta winding configuration;

FIG. 13 is a graph illustrating measured motor torque versus motor angle and electrical damping;

FIG. 14 is another embodiment of the electrical damping circuit of the present invention which employs a negative resistance in parallel with one winding of a delta circuit winding configuration for a motor;

FIG. 15 illustrates an active circuit for providing a current-voltage characteristic with negative slope so as to provide negative resistance for the damping circuit of FIG. 14;

FIG. 16 is an illustration of the delta windings of a motor wherein the windings are separated;

FIG. 17 is a circuit diagram of a motor configuration winding with a lead connected to the central node;

FIG. 18 is a block diagram of another embodiment of the present invention in which one winding of a wye motor winding configuration is used to sense rotor velocity and to drive currents into one or both of the other windings in order to oppose the rotor velocity so as to provide high degree of damping;

FIG. 19 is a block diagram of a damped commutation amplifier in accordance with one embodiment of the present invention; and

FIG. 20 is a block diagram of a haptic display using a damped commutation amplifier in accordance with the present invention.

### DETAILED DESCRIPTION OF THE INVENTION

An electrical damping system of the present invention provides damping on the electrical side of a drive motor 10 by placing electrical resistance 12 in parallel with the motor 10 as shown in FIG. 1 or by placing series connected electrical resistance 12 and capacitance 14 in parallel with the motor 10 as shown in FIG. 2. It should be appreciated that the resistance 12 may be provided by one or more resistors connected to provide an equivalent resistance Rₗ. Similarly, the capacitance 14 may be provided by one or more capacitors connected to provide an equivalent capacitance C.

The electrical damping system of the present invention has many applications. For example, the electrical damping system can be used in a feedback control system to damp high feedback gain that could make the system unstable. The electrical damping system can also be used in systems where the energy to be damped is internal to the system such as where the energy arises from the control of a device. One such system is a haptic display which will be described in detail herein. A haptic display has a user interface, such as a handle or other user actuable input device, that is coupled to a motor to provide tactile or haptic feedback to the user when interacting with robotics or other virtual environments or the like. The haptic display includes a number of sensors that monitor position, acceleration, etc. of the motor's output shaft or the like. The sensors are coupled to a computer that controls the motor in response to the sensor outputs so that the motor can simulate a force opposing movement of the user interface when the device hits a virtual wall. The motor 10 of FIGS. 1 and 2 represents the motor of a haptic display; however, it is illustrative of any controlled device in a feedback system where it is desirable to damp an abrupt change in feedback gain or a high feedback gain. The equivalent mechanical damping that the electrical system of FIG. 1 adds is

$${B}_{eq} = \frac{{K}_{t}^{2}}{( {R}_{1} + {R}_{m} )}$$

where Kₜ is the motor's torque constant, Rₘ is the motor's internal resistance, and Rₗ is the added parallel resistance.

With only an added resistor the electrical system acts just as a mechanical damper, dissipating energy throughout the device's range of motion. An improvement can be made, however, by adding a capacitor in series with the added parallel resistance as shown in FIG. 2. The added capacitance makes the electrical damping frequency dependent. The values of resistance and capacitance can be chosen to give the system a cutoff frequency around the normal bandwidth of human hand motion (a relatively small 2 Hz to 4.5 Hz) for a haptic display, i.e. a tactile feedback system. Thus, away from any constraints, when movement is governed almost entirely by inputs from the human user, the system acts as if there is no extra damping. When a high frequency event occurs, such as the user impacting a virtual wall, the electrical damping can serve to prevent the energy growth that leads to limit cycle oscillations and other instabilities. This method of providing real physical electrical damping, therefore, eliminates the need for hard to work with mechanical dampers while also simplifying the control structure and device design by doing away with the need for negative virtual damping.

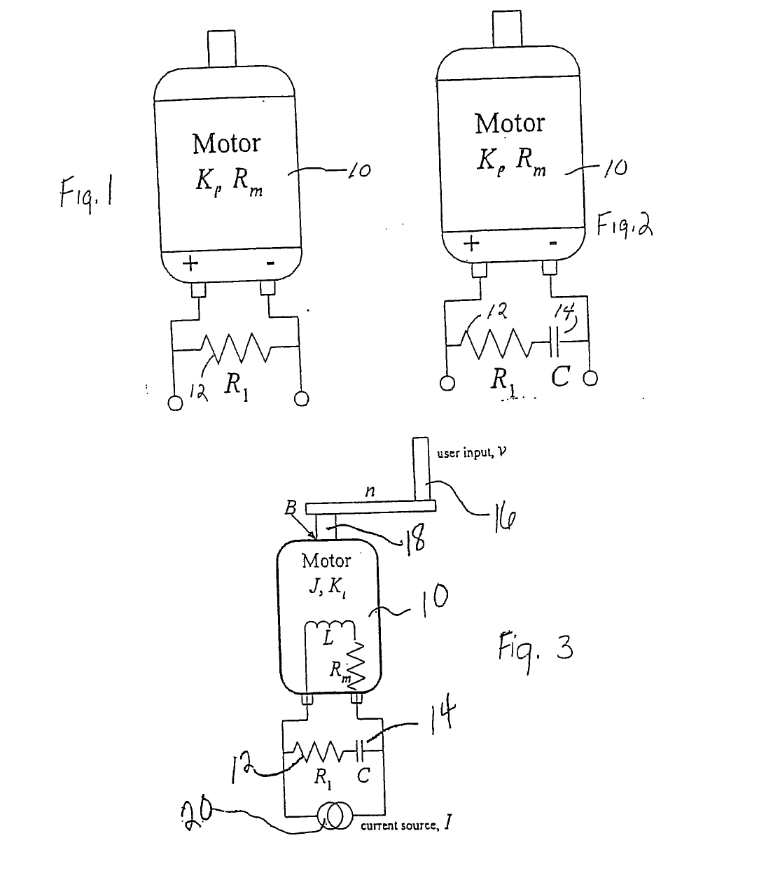

To further understand the behavior of an electrically damped system, a one degree-of-freedom device with electrical damping can be modeled as shown in FIG. 3. This haptic display system has a crank handle 16 coupled to the shaft 18 of the motor 10. The series resistance 12 and capacitance 14 is connected in parallel with the current source 20 for the motor so that the electrical damping is in parallel with the motor. This system has the following system transfer function.

$$τ ( s ) = {K}_{t} n [ \frac{{R}_{1} Cs + 1}{{LCs}^{2} + ( {R}_{1} + {R}_{m} ) Cs + 1} ] I ( s ) \\ - [ \frac{{K}_{t}^{2} {n}^{2} Cs}{{LCs}^{2} + ( {R}_{1} + {R}_{m} ) Cs + 1} + {n}^{2} ( B + Js ) ] v ( s ) \qquad ( 2 a )$$

where:

τ(s)=motor torque

Kₜ=motor's torque constant

n=transmission ratio

L=motor's inductance

Rₘ=motor's internal resistance

B=inherent mechanical damping of system

J=mechanical inertia of system

Rₗ=added parallel resistance

C=added parallel capacitance

I(s)=current from amplifier

ν(s)=angular velocity of motor output shaft

Here, it is seen that the torque, τ, is a function of two inputs: the current from the amplifier, I, and the angular velocity, ν, of the motor shaft 18.

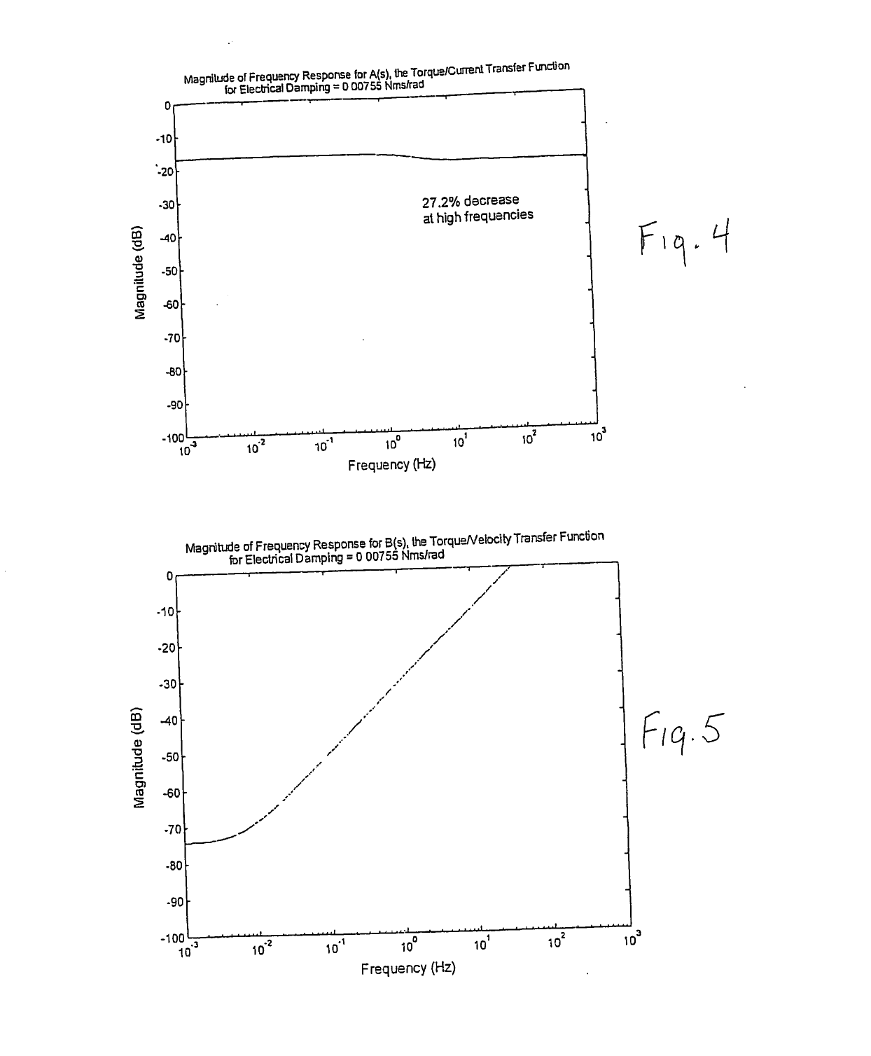

The system characteristics of the device used in testing as described below can be substituted in equation 2a and the resulting frequency responses can be plotted to obtain a fuller picture of haptic display performance. First, velocity is assumed to be zero and the resulting plot of the magnitude of A(s) shown in FIG. 4 depicts the frequency response of torque to a current input. It is desirable to have this plot constant, or as close as possible, because any shift in this effective torque constant corresponds to a change in the ability of a commanded current to output a desired torque. While the goal of electrical damping is to dissipate unwanted energy at high frequencies, the ability to control the haptic display with current commands of reasonable magnitude, at all frequencies, must be maintained.

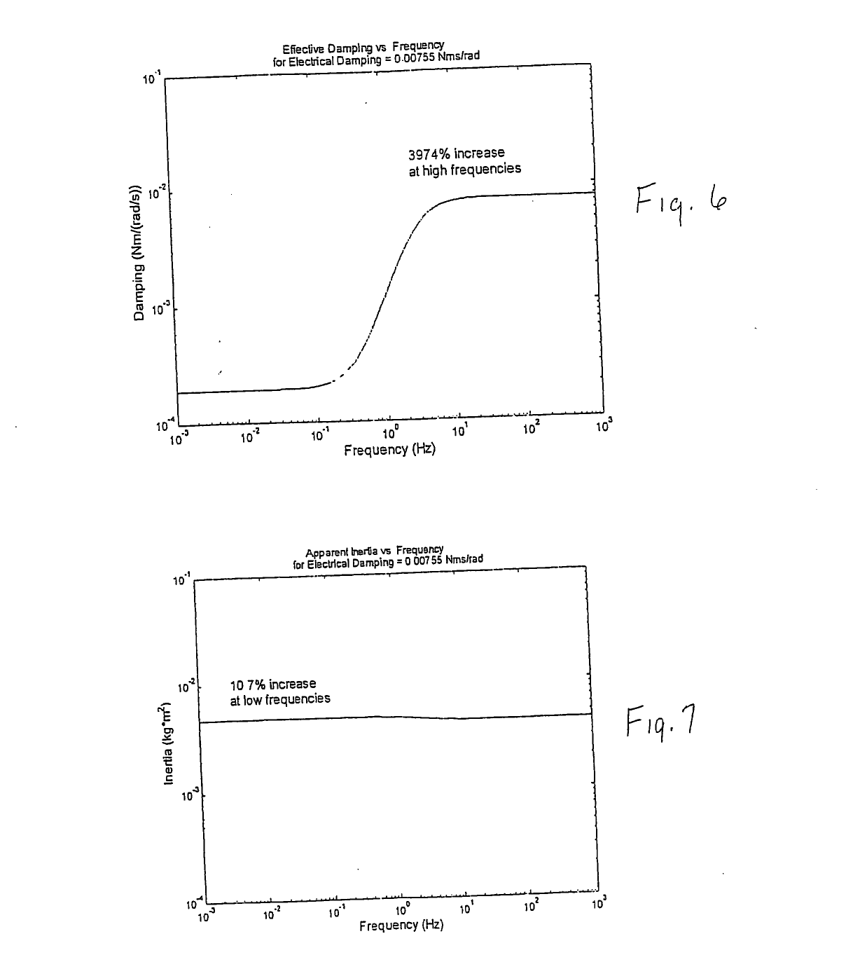

If current rather than velocity is assumed zero, the magnitude of B(s), the transfer function from velocity input to torque output can be plotted as seen in FIG. 5. This magnitude can be further broken down into its real and imaginary components. See, for example FIGS. 6 and 7. Re {A(s)} corresponds to the effective damping of the system while Im {B(s)}/ω represents the apparent inertia felt at the device output. From these plots it is clear that significant additional damping is added to the system at high frequencies, and only high frequencies. Also, motions at low frequencies experience only a slight increase in system inertia due to the added parallel capacitance. Thus, electrical damping can aid in stabilizing high frequency events like an impact with a virtual wall, while not hindering a user's unconstrained motion away from the boundary. Furthermore, this is possible without greatly affecting the ability to control the haptic display with a command current

It is important to note that, as with any design, the integration of electrical damping into a haptic display device involves a number of tradeoffs. It can be seen that the amount of electrical damping introduced into a given system is maximized when Rₗ, the added parallel resistance, is minimized. Thus,

$${max}_{{R}_{1}} {B}_{eq} = \frac{{K}_{t}^{2}}{{R}_{m}} .$$

This suggests that to get the greatest benefit from an electrically damped system, a motor with a large torque constant relative to its internal resistance should be chosen. But as Rₗ is decreased the drop in effective torque constant at high frequencies as seen in FIG. 4 increases. This requires an increase in command current to output high frequency torques. Additionally, as Rₗ is decreased, the capacitance in the system needs to be increased to keep the cutoff for the frequency dependent electrical damping, as seen in FIG. 6, constant. Aside from the practical issue of getting larger capacitors, the added capacitance is the only characteristic of the electrically damped system that has an adverse affect on the device's behavior when modeling low impedances. Thus, it is desirable to keep the added capacitance small to minimize any perceived increase in inertia for the user.

To test the practical application of electrical damping, a one degree-of-freedom haptic display has been designed and built. The device consists of a DC brushed motor (Kₜ=0.1441 Nm/A, Rₘ=0.75Ω) attached to an optical encoder with a resolution of 120,000 counts per revolution. Also attached to the motor shaft is a crank handle, 0.15 meters in length, and all of these components are mounted inside an aluminum frame.

To add electrical damping to the system, arrays of readily available 2200 μF bipolar capacitors and various power resistors are combined to give one of two circuits. The first has an equivalent capacitance of 0.022 F in series with an equivalent resistance of 2Ω and the second has an equivalent capacitance of 0.044 F in series with an equivalent resistance of 0.625Ω. Either one of these circuits can be placed in parallel with the motor to create a system with frequency dependent electrical damping. Both circuits have a cutoff frequency of approximately 2.6 Hz. They add 0.00755 Nms/rad and 0.0151 Nms/rad of electrical damping respectively. A 300 MHz Pentium II personal computer, running QNX 6.2 operates the control system for the device. It sends signals, to the motor amplifier via a 13-bit DAC board. An oscillator on the same data acquisition board is used to generate interrupts at 10 kHz, to which the output is latched electronically.

The virtual environment implemented by the control system is a common virtual wall model consisting of a virtual spring and damper in mechanical parallel coupled with a unilateral constraint operator. The virtual spring stiffness, K, and the virtual damping coefficient, B, are set in software and can be changed to vary the type of virtual wall being displayed. In effect, the wall model is a version of proportional-derivative (PD) control. For use in this feedback loop, position is obtained by the system's encoder and a velocity estimate is calculated using backward difference differentiation and a second order low pass software filter with a cutoff frequency of 30 Hz.

This implementation lends itself to using Z-width plots to classify the impedance range of the system. Because the points at which the system can no longer model a wall stably can be classified by the unstable wall model's stiffness and damping, they can be plotted on the virtual damping and virtual stiffness axes. Thus a visual representation of various systems' impedance ranges can be compared. As a means for determining the stability of a given wall model, the motor is provided with an offset torque to drive the handle into the virtual wall. Once at the wall, the virtual model counteracts the offset torque and brings the handle to rest if the wall model is stable. If unstable limit cycles occur, however, the handle will oscillate with a noticeable amplitude at the wall boundary, as measured by the system's encoder, and the given wall model is then classified as being outside the system's range of stable impedances. While haptic display devices are specifically designed for interaction with a human operator, an automated stability test that takes the human out of the loop was used so that variations between user grasps would not affect the experimentally determined stability boundaries. Furthermore, experience has shown that the human operator tends to add mechanical damping to the system as impacts with the virtual wall occur. Using a constant torque method, therefore, leads to a conservative estimate of the device's impedance range.

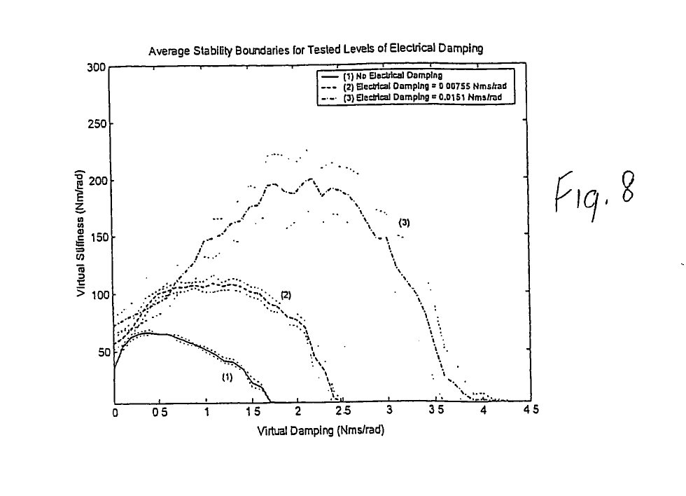

Tests were conducted for systems with no electrical damping, electrical damping of 0.00755 Nms/rad, and electrical damping of 0.0151 Nms/rad. FIG. 8 summarizes these tests with a plot of the average stability boundaries for all three cases. A larger area under the curve represents a greater number of virtual walls, or a larger impedance range, that the device can display stably. From this, it is clear that the addition of electrical damping dramatically increases the scope of a haptic display's usefulness. Also, because higher peak values in stiffness and damping tend to correspond to more realistic walls as judged by the user, electrical damping greatly increases the effectiveness with which a device will display virtual walls. Plus or minus one standard deviation for each curve is also plotted in FIG. 8 and this illustrates a larger variance in the highest damping runs, especially near the curve's peak. This reflects the increased effects of nonlinearities including friction, encoder quantization, and amplifier deadband at the higher impedance levels.

An automated stability test has been used to expedite data collection, but this should not suggest that users cannot perceive the improvements made by the addition of electrical damping. In fact, if a wall model is chosen away from the stability boundaries in FIG. 8, the difference between levels of electrical damping are immediately felt upon impacting the virtual wall with a standard four fingered grip on the handle.

One adverse effect of the electrical damping technique is a small reduction in “torque constant”, i.e., the magnitude of A(jω), at high frequency. A series of measurement of A(jω) were made by fixing the endpoint to a force sensor and driving the system with sinusoidal currents at various frequencies. The experimentally determined magnitude of this transfer function was found to be quite similar to that predicted by the system model. This confirms that improved practical performance is achievable through the implementation of frequency dependent electrical damping.

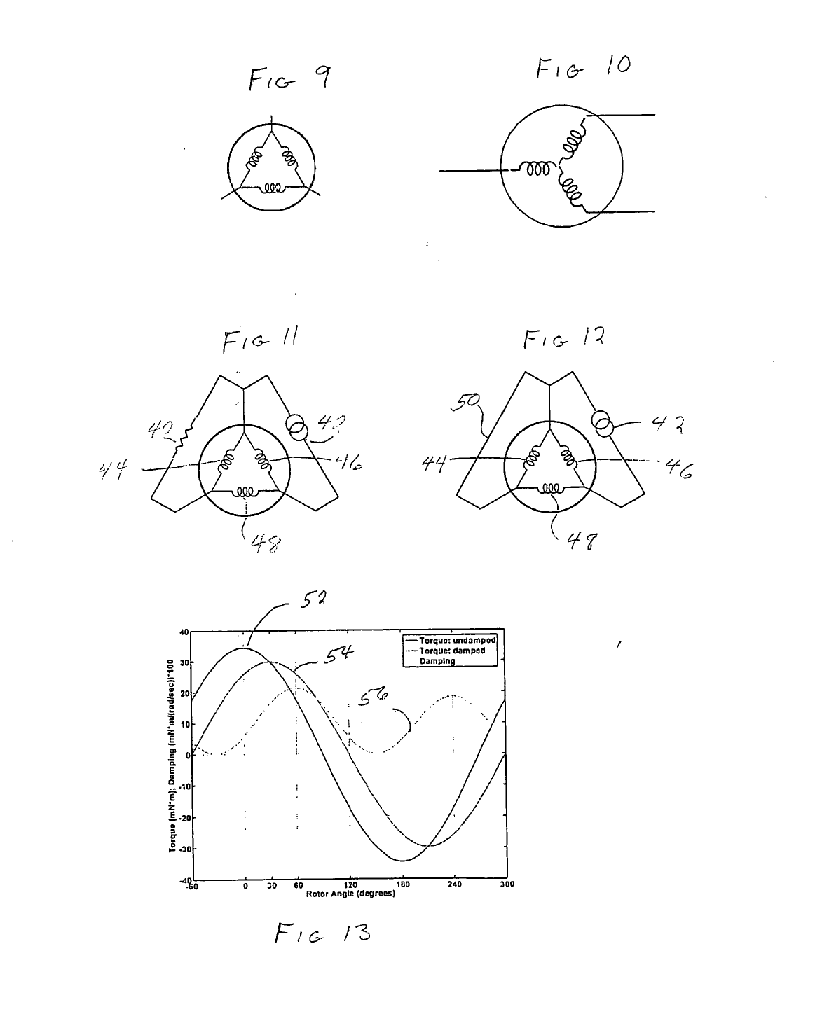

The electrical damping system of the present invention can also be used with motors having multiple windings such as motors having a delta motor winding configuration as shown in FIG. 9 or motors having a wye motor winding configuration as shown in FIG. 10. Specifically, the electrical damping system for a delta motor winding configuration as shown in FIG. 11 includes a resistor 40 in parallel with one winding 44 of the motor while a current source 42 is driving a current through another winding 46 of the motor where the delta motor winding configuration includes a third winding 48. Thus, the winding 46 is energized by the current source while the winding 44 is used for damping by connection to the resistor 40. In the embodiment of FIG. 12, damping is providing by a short 50 across the winding 44. As the rotor turns, the back emf induced in the winding 44 creates a current and a torque that opposes the rotation of the motor and provides damping.

FIG. 13 illustrates the motor torque versus rotor angle waveform 52 for an undamped motor and the motor torque versus rotor angle waveform 54 for a damped motor as well as the damping 56 added by a shorted winding as depicted in FIG. 12. The damping is velocity dependent so that the faster the rotor turns, the more damping is provided. The graph of FIG. 13 illustrates that when a non-damped motor is compared to a damped motor, the peak torque decreases by about 16 percent and the phase of the torque peak shifts by approximately 30 degrees. This figure also illustrates that the damping is dependent on the rotor angle due to the phase dependent coupling between the rotor poles and the shorted winding.

The maximum damping that can be obtained is limited by the inherent resistance of the winding used for the damping. To obtain greater damping, a negative external resistance can be used as illustrated by the negative resistance 58 in FIG. 14. This negative resistance may be obtained by an active circuit such as shown in FIG. 15 that can be used to produce a current-voltage characteristic having a negative slope.

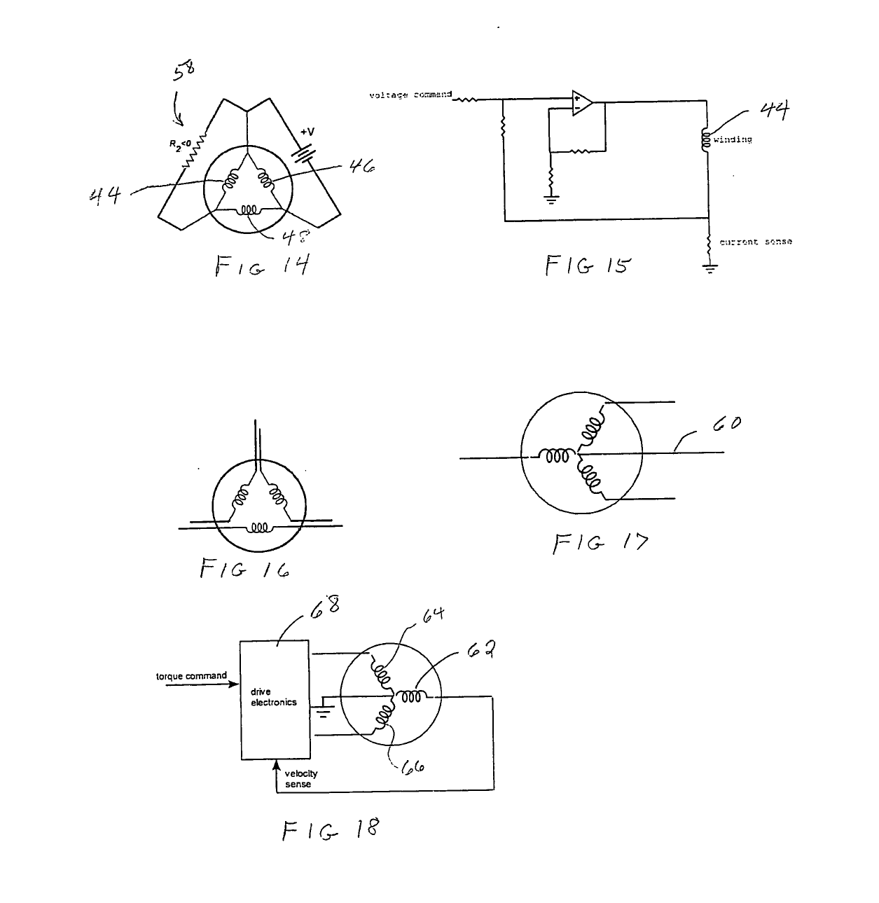

In the embodiments of FIGS. 11 and 14, one can think of the resistor 40, 58 as producing damping by sensing motor velocity as a voltage and producing, in response to the sensed voltage, a torque by creating a current where the torque is in opposition to the velocity of the motor's rotor. In these embodiments, the velocity sensing and torque creation are done through a single winding of the motor. Greater versatility can be accomplished by using one winding as a sensing winding and one or more other windings for actuation, i.e. torque creation. To accomplish this, the windings of a delta motor winding configuration can be separated as shown in FIG. 16, or a lead 60 can be connected to the central node in the wye motor winding configuration as depicted in FIG. 17. In FIG. 18, one winding 62 of the wye motor winding configuration is used to sense the velocity of the motor's rotor and to drive currents into one or both of the other windings 64 and 66 in order to oppose the rotor velocity. Commutation of the sensing winding 62 and of the actuation windings 64, 66 can be accomplished by a commutation amplifier designed for that purpose. It should be appreciated that in such a damped commutation amplifier configuration, a linear combination of several winding voltages may be used for sensing. Further, actuation, i.e. torque creation or generation, may take place using a linear combination of multiple windings as well. In this embodiment, the combination of windings used for sensing is preferably orthogonal to the combination of windings used for actuation. A damped commutation amplifier allows commutation of the sensing and actuation windings to be accomplished smoothly and continuously as the rotor rotates. The drive electronics 68 for a damped commutation amplifier preferably include a microprocessor 70 operating in accordance with commutation logic and a three phase MOSFET drive 72 as well as a voltage sensing circuit 74 and current sensing 76 as shown in FIG. 19. The microprocessor 70 is responsive to the voltage across a linear combination of the windings to control the MOSFET drive 72 to maintain the voltage across a linear combination of at least two of the windings at or near zero. As the rotor rotates, commutation of the sensing and actuation windings can be done smoothly and continuously under the control of the microprocessor 70

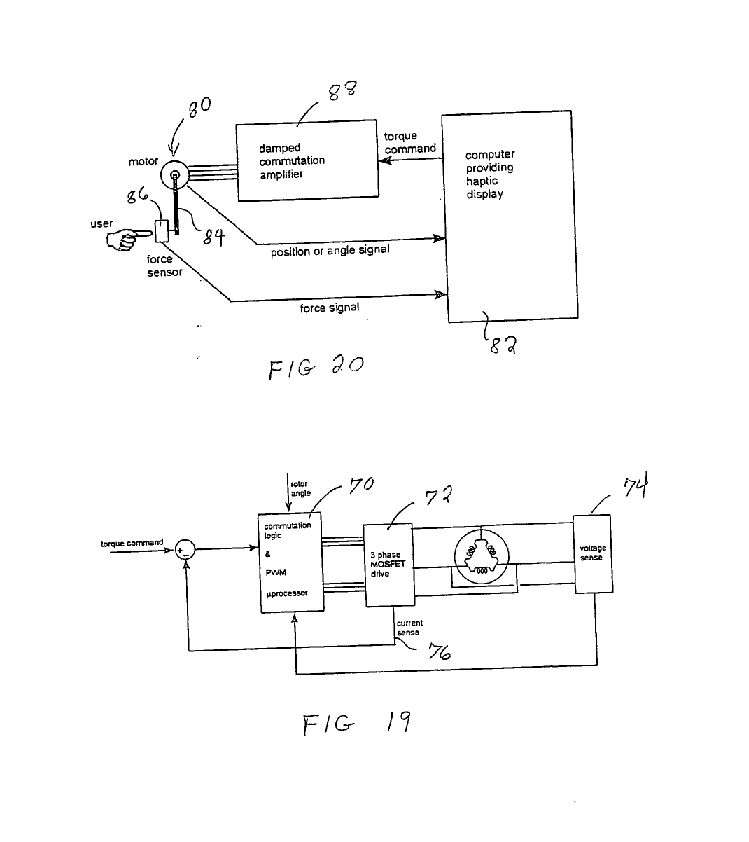

FIG. 20 illustrates a haptic display with a motor 80. The motor 80 may be a DC brushless rotary motor having an associated position sensor, such as a rotary encoder, that provides a position signal or rotary angle signal to a computer 82 of the haptic display. A user interfaces with a lever arm 84, or the like, where the lever arm 84 is coupled to the motor 80. A force sensor 86 or load cell provides a signal to the computer 82 representing the force applied by the user on the lever arm 84. The damped commutation amplifier 88 provides electrical damping for the motor 80 to stabilize the system and thus allow high feedback gain.

Many modifications and variations of the present invention are possible in light of the above teachings. Thus, it is to be understood that, the invention may be practiced otherwise than as described hereinabove.

What is claimed is:

1. A system for use in a haptic display for providing haptic feedback to a user comprising:
a motor having a pair of leads;
an electrical damping system including an electrical resistance connect across the leads so as to be in parallel with the motor; and
a user interface coupled to the motor to provide haptic feedback to the user.

2. A system for use in a haptic display for providing haptic feedback to a user as recited in claim 1 wherein said electrical damping system includes a capacitance connected in series with the electrical resistance, the series connected resistance and capacitance being connected in parallel with the motor.

3. A system for use in a haptic display for providing haptic feedback to a user comprising:
a motor having at least two windings;
an electrical damping circuit connected across one or more of the windings; and
a user interface coupled to the motor to provide haptic feedback to the user.

4. A system for use in a haptic display for providing haptic feedback to a user as recited in claim 3 wherein the electrical damping circuit includes a resistance coupled across one or more of the windings.

5. A system for use in a haptic display for providing haptic feedback to a user as recited in claim 4 wherein the resistance is provided by a circuit having a current-voltage characteristic with a negative slope.

6. A system for use in a haptic display for providing haptic feedback to a user as recited in claim 3 wherein the electrical damping circuit includes a short coupled across a linear combination of windings.

7. A system for use in a haptic display for providing haptic Feedback to a user as recited in claim 3 wherein the electrical damping circuit is a damped commutation amplifier.
